(19) United States
(12) Patent Application Publication
(10) Pub. No.: US 2014/0167592 A1
(43) Pub. Date: Jun. 19, 2014

(54) HEAT REMOVAL DESIGN FOR LED BULBS

(71) Applicant: Switch Bulb Company, Inc., San Jose, CA (US)

(72) Inventors: Ronald J. LENK, Woodstock, GA (US); Carol LENK, Woodstock, GA (US); Daniel CHANDLER, Menlo Park, CA (US); Matthew GALLA, Mountain View, CA (US)

(73) Assignee: SWITCH BULB COMPANY, INC., San Jose, CA (US)

(21) Appl. No.: 14/011,636

(22) Filed: Aug. 27, 2013

Related U.S. Application Data
(63) Continuation of application No. 12/299,003, filed on May 7, 2009, now Pat. No. 8,547,002.
(60) Provisional application No. 60/797,187, filed on May 2, 2006.

(51) Int. Cl. F21V 29/00

(52) U.S. Cl. CPC F21V 29/248
USPC 313/46; 445/38

(57) ABSTRACT

An LED bulb having bulb-shaped shell and thermally conductive fluid or gel within the shell. The bulb includes at least one LED within the shell. The bulb includes at least one LED within the shell and a base. The base can be configured to fit within an electrical socket and can include a series of screw threads and a base pin, wherein the screw threads and base pin are dimensioned to be received within a standard electrical socket. Alternatively, the base can be configured to fit within a suitable electric socket.

### CROSS-REFERENCE TO RELATED APPLICATION

This application claims priority to U.S. Patent Provisional Application No. 60/797,187, filed May 2, 2006, which is incorporated herein by this reference in its entirety.

### FIELD OF THE INVENTION

The present invention relates to replacement of bulbs used for lighting by light emitting diode (LED) bulbs, and more particularly, to the efficient removal of the heat generated by the LEDs in order to permit the replacement bulb to match the light output of the bulb being replaced.

### BACKGROUND OF THE INVENTION

An LED consists of a semiconductor junction, which emits light due to a current flowing through the junction. At first sight, it would seem that LEDs should make an excellent replacement for the traditional tungsten filament incandescent bulb. At equal power, they give far more light output than do incandescent bulbs, or, what is the same thing, they use much less power for equal light; and their operational life is orders of magnitude larger, namely, 10-100 thousand hours vs. 1-2 thousand hours.

However, LEDs have a number of drawbacks that have prevented them, so far, from being widely adopted as incandescent replacements. Among the chief of these is that, although LEDs require substantially less power for a given light output than do incandescent bulbs, it still takes many watts to generate adequate light for illumination. Whereas the tungsten filament in an incandescent bulb operates at a temperature of approximately 3000° (degrees) K, an LED, being a semiconductor, cannot be allowed to get hotter than approximately 120° C. The LED thus has a substantial heat problem: If operated in vacuum like an incandescent, or even in air, it would rapidly get too hot and fail. This has limited available LED bulbs to very low power (i.e., less than approximately 3 W), producing insufficient illumination for incandescent replacements. One additional method for getting a “white LED” is to use a colored cover over a blue or other colored LED, such as that made by JKL Lamps™. However, this involves significant loss of light.

One possible solution to this problem is to use a large metallic heatsink, attached to the LEDs. This heatsink would then extend out away from the bulb, removing the heat from the LEDs. This solution is undesirable, and in fact has not been tried, because of the common perception that customers will not use a bulb that is shaped radically differently from the traditionally shaped incandescent bulb; and also from the consideration that the heatsink may make it impossible for the bulb to fit in to pre-existing fixtures.

This invention has the object of developing a light emitting apparatus utilizing light emitting diodes (LEDs), such that the above-described primary problem is effectively solved. It aims at providing a replacement bulb for incandescent lighting having a plurality of LEDs with a light output equal in intensity to that of an incandescent bulb, and whose dissipated power may be effectively removed from the LEDs in such a way that their maximum rated temperature is not exceeded. The apparatus includes a bulb-shaped shell, preferably formed of a plastic such as polycarbonate. The shell and/or the bulb may be transparent, or may contain materials dispersed in it to disperse the light, making it appear not to have point sources of light, and may also contain materials dispersed in it to change the bluish color of the LED light to more yellowish color, more closely resembling the light from normal incandescent bulbs.

### SUMMARY OF THE INVENTION

In accordance with one embodiment, an LED bulb comprises: a bulb-shaped shell, wherein the shell may be any shape, or any of the other conventional or decorative shapes used for bulbs; a thermally conductive fluid within the bulb-shaped shell; at least one LED within the bulb-shaped shell; and a base dimensioned to be received within an electrical socket.

In accordance with another embodiment, a method of manufacturing an LED bulb comprises: creating a plastic bulb-shaped shell; at least partially filling the shell with a fluid, wherein the fluid is thermally conductive; and installing at least one LED in the fluid.

In accordance with a further embodiment, a method of manufacturing an LED bulb comprises: creating a plastic bulb-shaped shell; installing at least one LED within the plastic bulb-shaped shell; and at least partially filling the shell with a fluid, wherein the fluid is thermally conductive.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a cross-sectional view of an LED replacement bulb showing the light-emitting portion of an LED mounted in a fluid.

FIG. 2 is a cross-sectional view of an LED replacement bulb showing an LED embedded in the shell, while remaining in thermal contact with the fluid.

FIG. 3 is a cross-sectional view of an LED replacement bulb showing a plurality of LEDs mounted in a fluid.

### DETAILED DESCRIPTION

Reference will now be made in detail to the present preferred embodiments of the invention, examples of which are illustrated in the accompanying drawings. Wherever possible, the same reference numbers are used in the drawings and the description to refer to the same or like parts. According to the design characteristics, a detailed description of each preferred embodiment is given below.

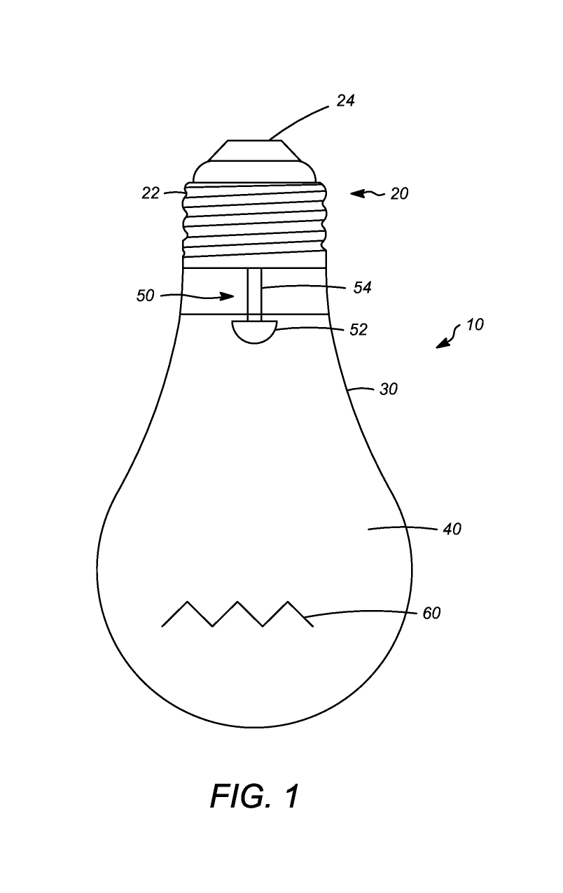

FIG. 1 shows a cross-sectional view of an LED replacement bulb 10 showing the light-emitting portion of the LED mounted in a fluid according to one embodiment. As shown in FIG. 1, the LED replacement bulb 10 includes a screw-in base 20, a plastic shell 30, a fluid filled inner portion 40, and at least one LED 50. The screw-in base 20 includes a series of screw threads 22 and a base pin 24. The screw-in base 20 is configured to fit within and make electrical contact with a standard electrical socket. The electrical socket is preferably dimensioned to receive an incandescent or other standard light bulb as known in the art. However, it can be appreciated that the screw-in base 20 can be modified to fit within any electrical socket, which is configured to receive an incandescent bulb, such as a bayonet style base. The screw-in base 20 makes electrical contact with the AC power in a socket through its screw threads 22 and its base pin 24. Inside the screw-in base 20 is a power supply (not shown) that converts the AC power to a form suitable for driving the at least one LED 50. The power supply may also be located somewhere other than in the base, either in the bulb or completely external to it.

The at least one LED 50 includes a light emitting portion 52 and a pair of connecting wires 54, which are connected to the power supply. Typically, the light emitting portion 52 of an LED 50 consists of a die, a lead frame where the die is actually placed, and the encapsulation epoxy, which surrounds and protects the die and disperses and color-shifts the light. The die is bonded with conductive epoxy into a recess in one half of the lead frame, called the anvil due to its shape. The recess in the anvil is shaped to project the radiated light forward. The die's top contact wire is bonded to the other lead frame terminal, or post. It can be appreciated that the example set forth is only one embodiment of an LED and that other suitable LED 50 configurations can be used. As shown in FIG. 1, the shell 30 entirely encases the fluid-filled volume 40 so as to prevent leakage. The shell 30 also encases the at least the light-emitting portion 52 of the LED or LEDs 50, with the connecting wires 54 coming out through the shell 30 through a sealed connection to the power supply. It can be appreciated that the shell 30 (or enclosure) may be any shape, or any of the other conventional or decorative shapes used for bulbs, including but not limited to spherical, cylindrical, and “flame” shaped shells 30. Alternatively, the shell 30 could be a tubular element, as used in compact florescent lamps or other designs.

The shell 30 is filled, either completely or partially, with a thermally conductive fluid 60, such as water or a mineral oil. However, it can be appreciated that any suitable gel material can be used in place of the fluid 60, for example one which upon exposure to atmospheric pressure and/or air gels to prevents the fluid 60 from escaping from the bulb 10 if damaged or broken. For example, the gel like material can be hydrogenated poly (2-hydroxyethyl methacrylate). The fluid 60 acts as the means to transfer the heat generated by the LEDs 50 to the shell 30, where it may be removed by radiation and convection, as in a normal incandescent bulb. The fluid 60 may be transparent, or may contain materials dispersed in it to disperse the light, making it appear not to have point sources of light, and may also contain materials dispersed in it to change the bluish color of the LED light to more yellowish color, more closely resembling the light from normal incandescent bulbs. The fluid 60 is preferably electrically insulating. In addition, the fluid 60 is preferably in a static state within the shell 30.

The LEDs 50 are installed in the fluid in such a way as to prevent them from being shorted. If the fluid is electrically insulating, no special measures need to be taken. However, if the fluid is not electrically insulating, the electrically conductive portions of the LEDs 50 may be electrically insulated to prevent shorting.

When the at least one LED 50 or plurality of LEDs 50 are installed in the fluid 60, the shell 30 is sealed with a watertight seal, preferably with the same material as the shell 30. The electrical contacts for powering the LEDs 50 are brought out through the seal before the sealing is accomplished. These leads are connected to the power source for the LEDs, which will preferentially be included inside the remainder of the bulb. The power source is preferably designed to be compatible with pre-existing designs, so that the bulb may directly replace traditional bulbs without requiring any change in the pre-existing fixture.

In another embodiment, the shell 30 and/or the fluid 60 can include a plurality of bubbles (not shown), wherein the bubbles disperse the light from the at least one LED 50. In yet another embodiment, a dye (not shown) can be added to the shell 30 or the fluid 60 within the shell 30, wherein the dye shifts the light of the at least one LED 50 from a first color spectrum to a second color spectrum.

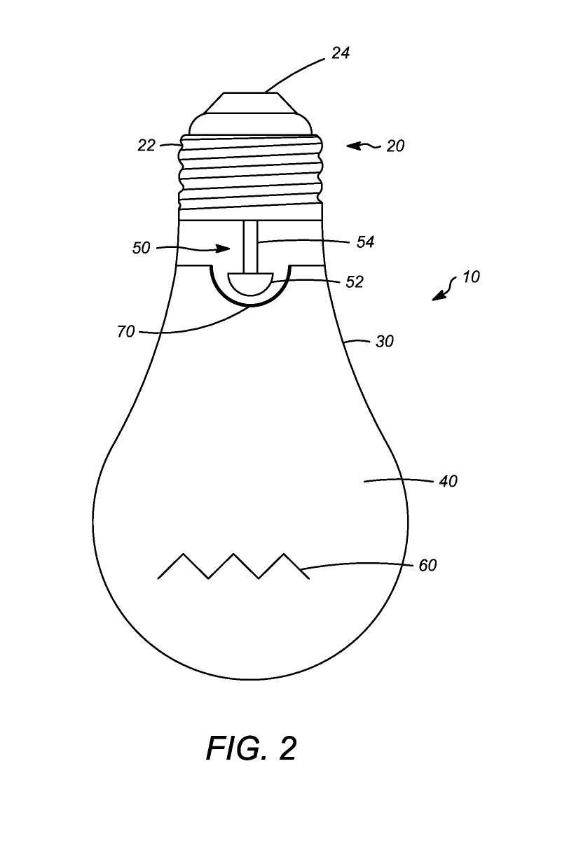

FIG. 2 shows a cross-sectional view of an LED replacement bulb 10 showing the LED 50 embedded in the shell, while remaining in thermal contact with the fluid 60 according to a further embodiment of this invention. The LED replacement bulb 10 includes a screw-in base 20, a shell 202, a fluid-filled volume 40, and at least one LED 50 with light-emitting part or parts 52. The screw-in base 20 makes electrical contact with the AC power in a socket through its screw threads 22 and its base pin 24. Inside the screw-in base 20 is a power supply (not shown) that converts the AC power to a form suitable for driving the at least one LED 50. The LED or LEDs 50 are comprised of two parts, connecting wires 54 that connect them to the power supply, and the LED or LEDs 52 themselves. The shell 30 entirely encases the fluid-filled volume 40 so as to prevent leakage. The shell 30 also encases the LED or LEDs 50, with the connecting wires 54 connecting to the power supply. In this embodiment, the LED or LEDs 50 are thermally connected to the fluid 40 through a thin shell-wall 70. This shell-wall 70 provides a low thermal resistance path to the fluid 40 for the heat dissipated by the LED or LEDs 50.

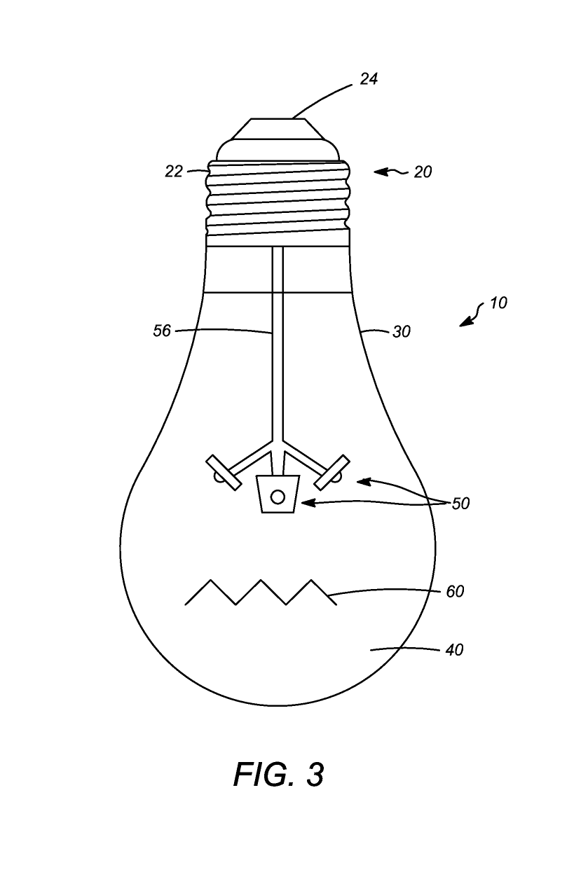

FIG. 3 shows a cross-sectional view of an LED replacement bulb 10 comprising a plurality of LEDs 50 mounted in the fluid according to another embodiment of this invention. The LED replacement bulb mainly includes a screw-in base 20, a shell 30, a fluid-filled volume 40, and a plurality of LEDs 50 with connector and support 56. The plurality of LEDs 50 are preferably at least 3 or 4 LED dies arranged to distribute the light source in a suitable configuration. In one embodiment, the plurality of LEDs 50 can be arranged in a tetrahedral configuration. The screw-in base 20 makes electrical contact with the AC power in a socket through its screw threads 22 and its base pin 24. Inside the screw-in base 20 is a power supply (not shown) that converts the AC power to a form suitable for driving the LED or LEDs. The LED or LEDs 50 are comprised of two parts, the connecting wires 56 that connect them to the power supply, and the LED or LEDs 50 themselves. The connecting wires 56 are stiff enough to function as support for the LED or LEDs 50, and also form the interconnects between the LEDs 50 when there are multiple devices. The shell 30 entirely encases the fluid-filled volume 40 so as to prevent leakage. The shell 30 also encases at least the LED or LEDs 50, with the connecting wires 56 coming out through the shell 30 through a sealed connection to the power supply. It can be appreciated that in another embodiment, the support may be a different material from the interconnections or connections.

It can be appreciated that the LED replacement bulbs as shown in FIGS. 1-3 are shown as replacement bulbs for standard incandescent bulbs, however, the bulbs 10 and methods as set forth herein can be adapted to usage with any other powering system or configuration, and can be used for any lighting system, including flashlights, headlights for automobiles or motorcycles, and lanterns.

It will be apparent to those skilled in the art that various modifications and variation can be made to the structure of the present invention without departing from the scope or spirit of the invention. In view of the foregoing, it is intended that the present invention cover modifications and variations of this invention provided they fall within the scope of the following claims and their equivalents.

1-140. (canceled)

141. A light emitting diode (LED) bulb comprising:
a shell;
a thermally conductive liquid in contact with the shell;
a plurality of LEDs thermally connected to the thermally conductive liquid, wherein the thermally conductive liquid and the shell are the only means to transfer heat generated by the plurality of LEDs;
a base, wherein the base is configured to receive electrical power; and
a support extending into the shell, wherein the plurality of LEDs is connected to the support.

142. The LED bulb as set forth in claim 141, further comprising a power source connected to the plurality of LEDs, and wherein the power source is compatible with pre-existing power sources, permitting the bulb to be used in pre-existing fixtures.

143. The LED bulb as set forth in claim 141, wherein the plurality of LEDs is thermally connected to the liquid through a shell-wall.

144. The LED bulb as set forth in claim 141, wherein the liquid is static.

145. The LED bulb as set forth in claim 141, wherein the liquid gels when exposed to air.

146. The LED bulb as set forth in claim 141, wherein the liquid is mineral oil.

147. The LED bulb as set forth in claim 141, wherein the liquid is water.

148. The LED bulb as set forth in claim 141, further comprising a plurality of bubbles within the liquid, wherein the bubbles are configured to disperse the light from the plurality of LEDs.

149. The LED bulb as set forth in claim 141, further comprising a dye added to the liquid, wherein the dye shifts the light of an LED in the plurality of LEDs from a first color spectrum to a second color spectrum.

150. The LED bulb as set forth in claim 141, further comprising a dye added to the shell, wherein the dye shifts the light of an LED in the plurality of LEDs from a first color spectrum to a second color spectrum.

151. The LED bulb as set forth in claim 141 wherein the plurality of LEDs is configured to emit light through the thermally conductive liquid and the shell.

152. The LED bulb as set forth in claim 141, wherein the LEDs are positioned proximate the middle of the interior volume of the shell.

153. A light emitting diode (LED) bulb comprising:
a shell;
a thermally conductive liquid within the shell, wherein the thermally conductive liquid is thermally connected to the shell;
a plurality of LEDs thermally connected to the thermally conductive liquid, wherein the thermally conductive liquid and the shell are the only means to transfer heat generated by the plurality of LEDs;
a base, wherein the base is configured to receive electrical power; and
a support within the shell, wherein the plurality of LEDs is connected to the support.

154. The LED bulb as set forth in claim 153, further comprising a power source connected to the plurality of LEDs, and wherein the power source is compatible with pre-existing power sources, permitting the bulb to be used in pre-existing fixtures.

155. The LED bulb as set forth in claim 153 wherein the plurality of LEDs is configured to emit light through the thermally conductive liquid and the shell.

156. A method of manufacturing a light emitting diode (LED) bulb comprising:
creating a shell;
at least partially filling the interior of the shell with a thermally conductive liquid, wherein the thermally conductive liquid is in contact with the shell;
installing a plurality of LEDs on a support;
inserting the support with the LEDs within the shell; and
electrically connecting the plurality of LEDs to a base;
wherein the plurality of LEDs are thermally connected to the thermally conductive liquid, wherein the thermally conductive liquid and the shell are the only means to transfer heat generated by the plurality of LEDs.

157. The method as set forth in claim 156, further comprising installing a power source for the plurality of LEDs within the bulb, and wherein the power source is compatible with pre-existing power sources, permitting the bulb to be used in preexisting fixtures.

158. The method as set forth in claim 156, wherein installing the plurality of LEDs within the shell comprises:
mounting the plurality of LEDs on the support; and
installing the support within the bulb, wherein the plurality of LEDs is within the shell after the support is installed.

159. The method as set forth in claim 156, wherein the plurality of LEDs is configured to emit light through the thermally conductive liquid and the shell.

160. The method as set forth in claim 156, wherein the LEDs are positioned proximate the middle of the interior volume of the shell.
